(19) United States
(12) Patent Application Publication
(10) Pub. No.: US 2025/0058333 A1
(43) Pub. Date: Feb. 20, 2025

(54) NOZZLE FOR DISPENSING ADHESIVE AND METHODS OF DISPENSING ADHESIVE

(71) Applicant: 3M INNOVATIVE PROPERTIES COMPANY, St. Paul, MN (US)

(72) Inventors: Chase M. O'Brien, Roseville, MN (US); Steven E. Turch, Blaine, MN (US)

(21) Appl. No.: 18/718,596

(22) PCT Filed: Dec. 13, 2022
(86) PCT No.: PCT/IB2022/062145

§ 371 Date: Jun. 11, 2024

Related U.S. Application Data
(60) Provisional application No. 63/265,676, filed on Dec. 17, 2021.

(51) Int. Cl. B05B 1/06; B05C 5/02; C08K 5/5419; C09J 163/00; F16B 11/00

(52) U.S. Cl. CPC B05B 1/06; B05C 5/0212; C08K 5/5419; C09J 163/00; F16B 11/008

(57) ABSTRACT

The present disclosure provides inventive nozzles and applicators for dispensing adhesive. These nozzle comprise: a main body cavity and a cap releasably attached to the main body cavity; wherein the cap includes spaced orifices for dispensing adhesive on an outer surface of a male pipe and a sleeve extending inwardly from the cap into the main body cavity; wherein the main body cavity includes a barrel portion, a funnel portion and a conduit, and wherein the sleeve is sized to accommodate the outer surface of a selected male pipe.

### GOVERNMENT SUPPORT CLAUSE

This invention was made with government support under Subcontract No. 4000153415 to Prime Contract No. DE-AC05-OR22725 awarded by the Department of Energy (DOE). The government has certain rights in the invention.

### BACKGROUND

Conventionally, in the heating, ventilation and air conditioning (HVAC) heat exchanger industry, pipes are joined together using a process called brazing. Brazing is a pipe bonding process where metal objects are joined together by melting and flowing a filler metal into the joint. In most instances, the joints being joined are made of similar metals (i.e., copper/copper) therefore galvanic corrosion between joints is not a concern. However, in certain specialty applications, the two metal surfaces being joined are made up of dissimilar metals, and galvanic corrosion can become an issue leading to premature joint failure or compromise. Conventionally, these dissimilar metal joints are brazed together using the typical process, followed by a postprocessing step where a section of heat-shrink tubing is placed over the brazed joint and heated (to induce shrinkage) to form a watertight seal over the joint. The heat shrink tubing serves to eliminate or diminish galvanic corrosion between the two metals due to water bridging the gap between metal surfaces.

One major drawback of the current process above is that it involves multiple steps. The joint is first brazed, and then in a second step the heat shrink tubing is applied. This process is time consuming and requires individual heating of each individual joint in a complex assembly to induce shrinkage of the tubing.

Accordingly, what is needed in the industry is an easier, less time-consuming process or method of bonding two similar or dissimilar metals together that will both provide a strong joint and eliminate or minimize galvanic corrosion at the interface of the metals. One way in which to provide such process is to use a structural adhesive for bonding the two similar or dissimilar metals together. Exemplary adhesives are taught in U.S. Patent Application, Ser. No. 63/127,432, titled “Methods of Bonding Metal Articles and Articles Formed Thereby, Docket No. 83332US002, and U.S. Patent Application, Serial No. 63/127438, titled “Methods of Bonding Copper and Articles Formed Thereby,” Docket No. 83623US002, both of which are hereby incorporated by reference.

However, improvements in nozzles for delivering such structural adhesives to the metals to be bonded will further assist the industry by providing easier, less time-consuming processes or methods.

### SUMMARY

The present disclosure provides a nozzles and applicators for dispensing adhesive, as well as articles formed thereby. In one embodiment, the present disclosure provides a nozzle for dispensing adhesive. This nozzle comprises: a main body cavity and a cap releasably attached to the main body cavity; wherein the cap includes spaced orifices for dispensing adhesive on an outer surface of a male pipe and a sleeve extending inwardly from the cap into the main body cavity; wherein the main body cavity includes a barrel portion, a funnel portion and a conduit, and wherein the sleeve is sized to accommodate the outer surface of a selected male pipe.

In another embodiment, the present disclosure provides an alternative nozzle for dispensing adhesive, comprising: a main body cavity and a sleeve is sized to accommodate the outer surface of a selected male pipe; wherein the main body cavity includes a barrel portion, a funnel portion and a conduit; wherein the main body cavity and sleeve form a spaced opening for dispensing adhesive on the outer surface of a male pipe; a channel for an adhesive to flow through from the conduit to the spaced opening, wherein the channel is formed between sleeve and the funnel and barrel portions.

In yet another embodiment, the present disclosure provides a dual nozzle for dispensing adhesive. This dual nozzle comprises: a first main body cavity and a first cap releasably attached to the main body cavity; wherein the first cap includes spaced orifices for dispensing adhesive on an outer surface of a first male pipe and a first sleeve extending from the first cap; wherein the first main body cavity includes a barrel portion, a funnel portion and a conduit, and wherein the first sleeve is sized to accommodate the outer surface of a first male pipe; and a second main body cavity and a second cap releasably attached to the first main body cavity; wherein the second cap includes spaced orifices for dispensing adhesive on an outer surface of a second male pipe and a first sleeve extending from the second cap; wherein the second main body cavity includes a barrel portion, a funnel portion and a conduit, and wherein the second sleeve is sized to accommodate the outer surface of a second male pipe.

In another embodiment, the present disclosure provides an alternative dual nozzle for dispensing adhesive, comprising: a first main body cavity and a first cap releasably attached to the first main body cavity; wherein the first cap includes a first sleeve is sized to accommodate the outer surface of a first male pipe; wherein the first main body cavity includes a barrel portion, a funnel portion and a conduit; wherein the first cap and first sleeve form a first spaced opening for dispensing adhesive on the outer surface of the first male pipe; and a first channel for an adhesive to flow through from the conduit to the spaced opening, wherein the channel is formed between the first sleeve and the funnel and barrel portions; and a second main body cavity and a second cap releasably attached to the second main body cavity; wherein the second cap includes a second sleeve is sized to accommodate the outer surface of a second male pipe; wherein the second main body cavity includes a barrel portion, a funnel portion and a conduit; wherein the second cap and second sleeve form a second spaced opening for dispensing adhesive on the outer surface of the second male pipe; and a second channel for an adhesive to flow through from the conduit to the spaced opening, wherein the second channel is formed between the second sleeve and the funnel and barrel portions.

The present disclosure also provides methods of applying adhesive. In one embodiment, the method comprises: providing a nozzle described above; providing an adhesive to flow through the nozzle; providing a male pipe and a female pipe, wherein the male pipe comprises a first metal, and wherein the female pipe comprising a second metal; applying an adhesive composition to a male pipe; inserting at least a portion of the adhesive composition and the male pipe into the female pipe thereby forming an interface between the male pipe and the female pipe; and curing the adhesive composition to form an adhesive bond between the male pipe and the female pipe, wherein the cured adhesive composition limits corrosion of at least a portion of the male pipe, the female pipe, or both.

The phrase “adhesive composition” refers to a composition, which on its own or in combination with another composition may, once cured, adhere two materials together, thereby forming an adhesive bond. In some instances, an adhesive composition in combination with another adhesive composition can form an adhesive bond once the adhesive compositions are cured. In some such instances, the adhesive compositions may be the same, some such adhesive compositions can be referred to as one part or one component (1K) adhesives. Illustrative 1K adhesives include, for example 1K epoxy adhesives, 1K acrylate adhesives, 1K urethane adhesives, as well as hybrids of the above chemistries. In some instances, two adhesive compositions components may be different, some such adhesive compositions can be referred to as two part or two component (2K) adhesives. 2K adhesives are generally made up of a Resin (Part A) and a Hardener (Part B). Generally, these materials are mixed prior to application of the materials onto the substrate surface. After the two parts are mixed, curing can occur, not necessarily immediately and not necessarily without an outside influence (e.g., heat, energy, etc.). Illustrative 2K adhesives include, for example, 2K epoxy adhesives, 2K acrylate adhesives, and 2K urethane adhesives as well as hybrids of the above chemistries. It should be noted that there is no additional inference to be made from referring to a composition as first or second, it is merely for the sake of convenience and clarity.

The phrase “adhesive bond” is a result of curing the first and/or first and second precursor adhesive compositions. The adhesive bond in this case serves to adhere the joining region of the first article to the joining region of the second article.

The phrase “female article” refers to an article that has a hollow generally cylindrical body with an internal diameter. A female article can be a pipe with a larger starting diameter than the “male article” or be accomplished by flaring/widening the end of a smaller diameter pipe (i.e., flaring a “male article” so that it becomes a larger diameter member that can serve as a “female element”).

The phrase “male article” refers to an article that has a Hollow generally cylindrical body that fits within the female article and has an external diameter slightly less than the internal diameter of the female article. A male article can be a pipe with a smaller starting diameter than the “female article.” Generally, the difference between the outer diameter of the male article and the inner diameter of the female article is on the order of 2-50 thousandths of an inch, most typically 5-20 thousandths of an inch.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a perspective view of an exemplary nozzle of the present invention;

FIG. 2 is an exploded view of the nozzle of FIG. 1;

FIG. 3 is a side view of the nozzle of FIG. 1;

FIG. 4 is a cross-sectional view of the nozzle of FIG. 3 taken along line 4-4;

FIG. 4A is an enlarged view of a portion of FIG. 4;

FIGS. 5A and 5B are cross-sectional views of the nozzle of FIG. 4, showing application of adhesive to an exemplary male article by the nozzle;

FIG. 6 is a side view of another exemplary nozzle of the present invention;

FIG. 7 is a cross cross-sectional view of the nozzle of FIG. 6 taken along line 7-7;

FIGS. 8A and 8B are cross-sectional views of the nozzle of FIG. 6, showing application of adhesive to an exemplary male article by the nozzle;

FIG. 9 is a side view of an adhesive applicator including the nozzle of FIG. 1;

FIG. 10 is a view of another adhesive applicator including the nozzle of FIG. 6;

FIG. 11 is a cross sectional view of yet another exemplary nozzle of the present invention;

FIG. 12 is a perspective view of another exemplary nozzle of the present invention;

FIG. 13 is a perspective view of yet another exemplary nozzle of the present invention;

FIG. 14 is a cross section view of the nozzle of FIG. 13 taken along line 14-14 in FIG. 13; and

FIG. 15A-15D are illustrating example steps in the process of adhesively bonding a female and male article, where the adhesive was applied by the nozzle of the present invention.

### DETAILED DESCRIPTION

The present disclosure provides inventive nozzles and applicators that are useful for joining two articles together, specifically joining a female article and a male article. This process of joining the two articles is the equivalent of both the brazing and heat shrink tubing application steps are combined into a single operation. In this invention, the adhesive is applied by the nozzle onto the outside of the male pipe in a way that, when inserted into the female joint, it creates a sealed joint that irreversibly joins the two pipes together upon curing. At the same time, the adhesive is further applied onto the surface of at least the male end of the pipe along the length in order to act as a coating that inhibits galvanic corrosion. By following this process, the need for a heat shrink tubing to be applied to the system is eliminated. In certain special applications, the male end of the pipe only having enough adhesive applied to its surface to ensure formation of a sealed joint upon insertion into the female joint and curing may have additional adhesive further applied.

The methods disclosed herein are methods of forming a bond using the inventive nozzles and applicators of the present invention. The methods include a step of applying an adhesive composition to some portion of the end of at least the male article using one of the inventive nozzles; inserting the male element into the female article; and curing the adhesive composition. At least some portion of an external surface of the male article, the female article, or both can also have adhesive composition applied thereto. At least the external interface where both the male article and the female article are exposed to the atmosphere, referred to herein as an external interface, is coated with adhesive. The adhesive on the external interface does not necessarily assist in adhering the two articles together but does prevent or at least decrease the amount of galvanic corrosion that can happen at the interface of the two dissimilar metals.

The nozzles and applicators of the present invention provide at least the following benefits. First, the nozzle is specially designed to dispense a precise uniform thickness or tapered annular-shaped layer of adhesive onto the outer diameter or external surface of a tubular body, such as a pipe, along a portion of this axial length. Second, the nozzle will apply the adhesive coating in a sleeve like configuration, of predetermined length and tapered shape, and terminates as close as possible to the planar end of the tubular body. Both aspects assist in providing an adhesive configuration that bonds the outer diameter of a tubular body, such as a male article, to the inner diameter of another tubular body, such as a female article. The nozzles and applicators of the present invention also include the capability to extend the coating length of the adhesive to provide galvanic corrosion protection at the junction region. For instance, in this case, the adhesive itself may act as an insulator to prevent the corrosion that may occur when dissimilar metals are joined. Third, the nozzles and applicators of the present invention offer better control and minimization of adhesive stringing between the nozzle and the tubular body, thus producing a clearer adhesive separation. Adhesive stringing (or sometimes known as adhesive tailing) has been a known problem in the prior art to optimized adhesive dispensing. Adhesive stringing occurs when adhesive is left behind either on the applicator's nozzle and/or pulled into a string when the adhesive dispensing device is retracted from the adhesive that has been previously deposited onto a substrate. Adhesive stringing can bring about an undesirable consequence of fouling the delivery device's die lip, and thus compromising its future performance. For instance, with adhesive stringing, the adhesive may fall back into the opening of the nozzle where the pipe is inserted, and thereafter, when the next pipe is inserted into the nozzle, adhesive can inadvertently adhere to the inner diameter of the pipe. Also undesirable with stringing, adhesive can find its way onto the planer end of the tubular body, and as a result, the adhesive will likely be inside the interior of the tubular bodies after they have been bonded together, interfering with the flow of materials through the joined tubular bodies. Fourth, the nozzles and applicators of the present invention provide better control and repeatability in applying adhesive to outer diameters of tubular bodies, which significantly reduces time required to bond tubing while also providing a more consistent dispensing process. Last, the nozzles and applicators of the present invention allow unskilled laborers to create adhesive bonds between tubular bodies easily in place of skilled laborers typically needed to braze the tubular bodies, as discussed above.

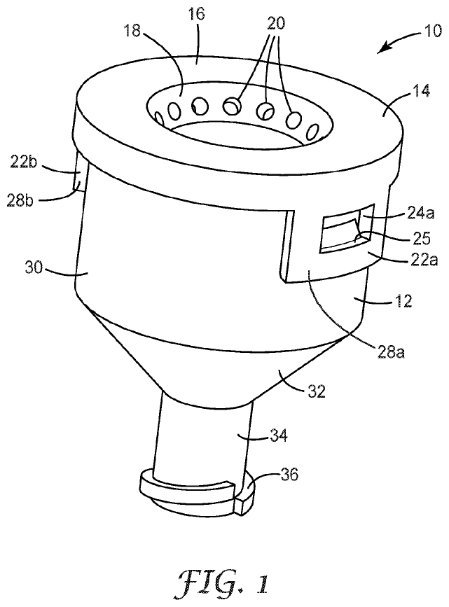

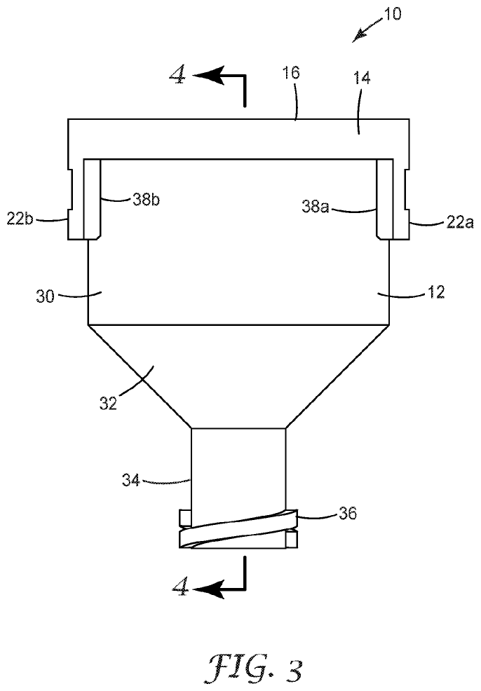

FIGS. 1, 2, and 3 illustrate one embodiment of the nozzle of the present invention which is useful for dispensing adhesive. Nozzle 10 includes a main body cavity 12 and a cap 14 which releasably attaches to the main body cavity 12. The main body cavity 12 includes a barrel portion 30, a funnel portion 32, and a conduit 34. The conduit 34 is in fluid communication with the funnel portion 32. The funnel portion 32 is in fluid communication with the barrel portion 30. The conduit 34 may include option threads 36 for attachment to an adhesive applicator. Alternatively, the conduit 34 may include other attachment mechanisms known in the art to attach the nozzle 10 to an adhesive applicator.

The cap 14 includes an attachment mechanism 22 to assist in releasably attaching the cap securely to the main body cavity 12. One embodiment of such an attachment mechanism 22 is illustrated in FIGS. 1-3. The cap 14 includes a first aperture 24a and a second aperture 24b, which are located opposite each other along coordinating wings 28a, 28b which extend from the outer surface 16 of the cap 14. The wings 28a, 28b of the cap 14 each include an attachment surface 25 adjacent each aperture 24a, 24b, respectively. The attachment surface 25a is designed to engage with first protrusion 38a on the external surface of the barrel portion 30 of the main body cavity 12. The attachment surface 25b is designed to engage with the second protrusion 38b on the external surface of the barrel portion 30 of the main body cavity 12. The protrusions 38a, 38b are positioned opposite each other on the external surface of the barrel portion. To assemble the cap 14 and the main body cavity 12, the apertures 24a, 24b of the cap are aligned with the protrusions 38a, 38b. The cap 14 is slidably engaged onto the barrel portion 30 of the main body cavity 12. The ramped protrusions 38a, 38b flex the wings 28a, 28b of the cap 14 as the attachment surfaces 25a, 25b near the apertures 24a, 25b engage with the angled side of the protrusions 38a, 38b and then slide into place with the engagement surface of the protrusions 38a, 38b. To disengage the cap 14 from the barrel portion 30 of the main body cavity 12, the cap 14 is rotated either clockwise or counterclockwise relative to the main body cavity 12 to disengage the attachment surfaces 25a, 25b of the cap from the protrusions 38a, 38b. Alternatively, the wings 28a, 28b may be flexed away from the barrel portion 30 to disengage the attachment surfaces 25a, 25b away from the protrusion 38a, 38b of the barrel portion 30.

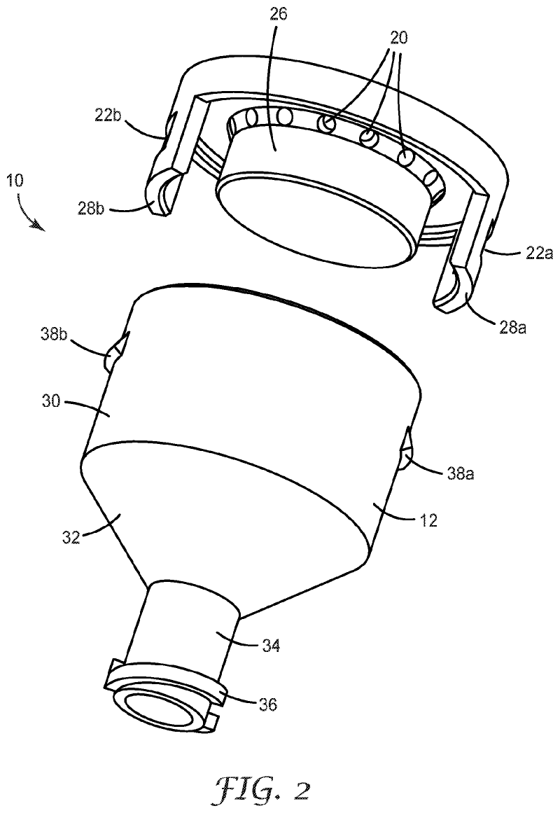

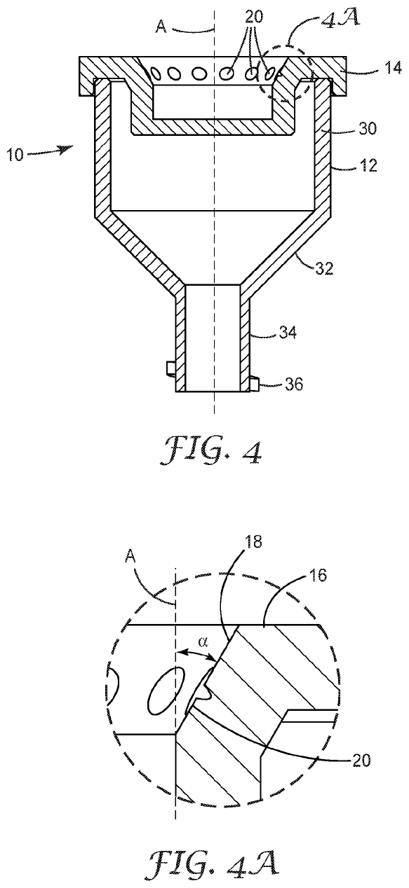

As illustrated in FIGS. 2 and 4, the inventive cap 14 has a sleeve 26 that extends inwardly from the outer surface 16 of the cap at a 90 degree angle relative to the outer surface 16. Preferably, the cap 14 includes an angled surface 18 connecting the sleeve 26 to the outer surface 16. The sleeve 26 is an annular sleeve which is selected to accommodate or is sized to fit the external surface 130 or diameter of a selected male pipe 50. The angled surface 18 includes annular spaced orifices 20. The annularly spaced orifices 20 and sleeve together are useful for applying adhesive on the outer or external surface of a tubular body, such as a male pipe, and provides the benefits explained above.

When assembled, the main body cavity 12 and cap 14 include axis A, as illustrated in FIG. 4. Axis A is useful for measuring the angle α of the orifices 20, as illustrated in FIG. 4A. The orifices 20 may be configured at an angle α of between 5 and 85 degrees relative to the axis A, in one embodiment. In another embodiment, the orifices 20 may be configured at an angle α of between 30 and 75 degrees relative to the axis A, preferably, or more preferably at an angle α of between 20 and 45 degrees relative to the axis A. The orifices 20 are preferably arranged at an angle to axis A, like they would be to the length of a male pipe, so that adhesive is dispensed through the spaced orifices in a sleeve-like coating. This inventive arrangement is in contrast to most prior art devices where adhesive is dispensed through orifices typically perpendicular to the length of male pipe, and most often the adhesive then tends to flow down into the opening of the nozzle and causes significant fouling of the adhesive applicator.

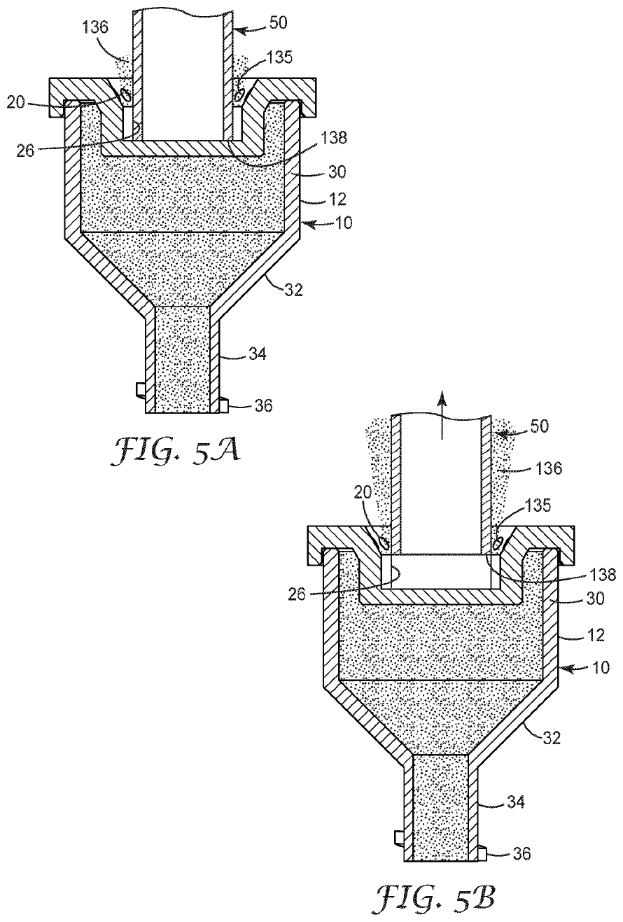

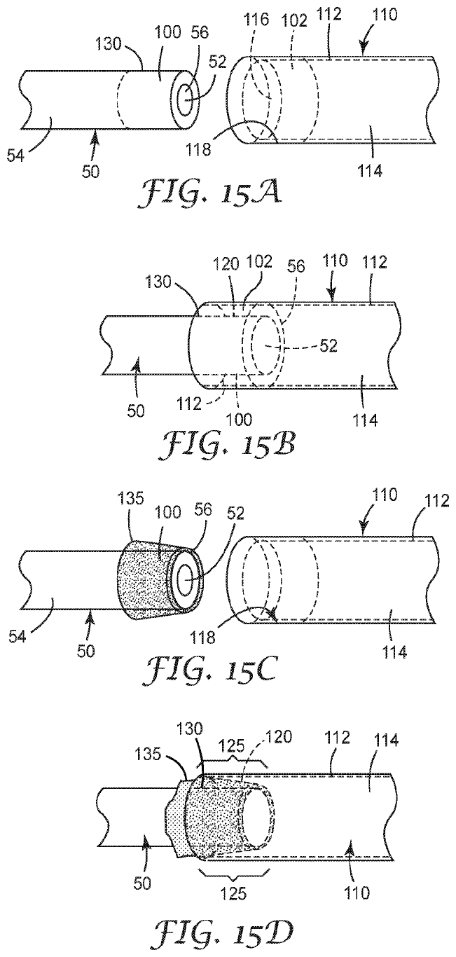

FIGS. 5A and 5B are convenient for illustrating the application of adhesive 135 onto the external surface 130 of a male article, such as a tubular body or male pipe 50. First, the male pipe 50 is selected having an outer diameter that fits well within the diameter of the circular sleeve 26, taking into account the expectation of the width of sleeve 136 of adhesive 135 to be applied to the outer diameter. As illustrated in FIG. 5A, the planar end 138 of the male pipe 50 is inserted into the sleeve 26 of the nozzle 10. The adhesive 135 then flows through the conduit 34 into the funnel portion 32 and then into the spaces between the cap 14 and the funnel portion 32. From there, the adhesive 135 will flow out of the annular spaced orifices 20 and be applied to the outer diameter of the male pipe 50, thus creating a sleeve of adhesive 136 on the outside of the male pipe 50. As the adhesive 135 is being applied, the male pipe 50 moves out of the nozzle in the opposite direction in which it was inserted into the nozzle 10. Specifically, the male pipe 50 is withdrawn from the sleeve 26 in a controlled linear movement to apply the sleeve-like coating 136 of adhesive 135 with a uniform thickness, as illustrated in FIG. 5B. Just prior to the planar end 138 exiting or withdrawing from the sleeve 26 of the nozzle 10, the adhesive 135 stops flowing out of the annularly spaced orifices 20. The movement of the male pipe 50 is determined at a rate in advance so as to apply the sleeve of adhesive 136 in a uniform thickness around the external surface 130 of the male pipe 50. In one embodiment, the adhesive 135 may be in a sleeve-like coating of adhesive is in a uniform shape axially, and is substantially uniform in thickness. The sleeve-like coating 136 may be tapered near the planar end 138 of the male pipe 50. Alternatively, in a preferred embodiment, the adhesive may be in a fully tapered arrangement, where it is thickest at one end of the sleeve of adhesive and narrowest at the opposite end of the sleeve of adhesive closest to planar end of the pipe. The angled geometry of the orifices 20 of the inventive nozzle 10 assists in tapered the adhesive. The nozzle 10 and applicator first begins to apply the adhesive 135 before the pipe 50 is moved. The adhesive continues to be applied as the pipe 50 moves relative to the nozzle. Then, the adhesive flow is shut off, followed by the pipe exiting the nozzle and due to the internal cohesive of the adhesive to pull itself toward the end of the pipe 50, resulting in an overall tapered sleeve of adhesive 136. It is advantageous to have the sleeve-like coating 136 fully tapered because the tapered coating allows the adhesive to get more easily into the overlap section of the joint between the male and female pipes in their respective joining regions 100, 118 more easily. This aspect is illustrated in FIGS. 15A-15D. If the adhesive coating isn't tapered, then it is possible that a significant amount of adhesive can potentially be scraped off or pushed out of the overlap of the joining regions, which typically happens in prior art adhesive applicators. Additionally, due to the nature of the adhesive, as some adhesive is scraped, more adhesive is often pulled with it reducing the amount in the joint.

One example range of thickness of the adhesive layer on the external surface of the male pipe as applied by the nozzle and applicator of the present invention is 0.125-0.1875 inches measured axially regardless of the pipe size. The length of the adhesive is dependent on the pipe size, but typically ranges from 0.25 to 0.75 inches. Together, these ranges create optimum sleeves of adhesive produced by the nozzle and applicators of the present invention. That being said, the type of adhesive 135 may be applied at any selected rate to obtain a desired thickness and length. Ideally, the sleeve-like coating of adhesive 136 is substantially not, and preferably not at all on the planer end 138 of the male pipe, after the nozzle 10 applies the adhesive 135. In addition, the sleeve-like coating of adhesive 136 is applied in a tapered manner, such that the axial diameter of the thickness may taper between 0.125-0.1875 inches.

The orifices 20 of the nozzle 10 are sufficiently small enough to break-up the adhesive when dispensing to minimize stringing. Previous prior art nozzles with larger orifices had issues stringing when dispensing was stopped the and tubing was removed from the prior device. Examples of suitable diameters for the annular orifices 20 range from 0.025 to 0.050 inches. In addition, dispensing is stopped just prior to removing the pipe from the nozzle 10. Typically approximately 0.01″ before the tubing end reached the dispensing orifices 20 allowing the adhesive that has been dispensed to be pulled to the end of the tubing.

FIGS. 6 and 7 illustrate an alternative embodiment of the nozzle 60 of the present invention. The nozzle 60 is very similar to nozzle 10, except it does not include a cap 14 and instead of annular spaced orifices the nozzle includes an annular spaced opening 70. Nozzle 60 includes a main body cavity 12. The main body cavity 12 includes a barrel portion 62, a funnel portion 64, and a conduit 66. The conduit 66 is in fluid communication with the funnel portion 64. The funnel portion 64 is in fluid communication with the barrel portion 62. The conduit 66 may include option threads 36 for attachment to an adhesive 15 applicator. Alternatively, the conduit 66 may include other attachment mechanisms known in the art to attach the nozzle 60 to an adhesive applicator.

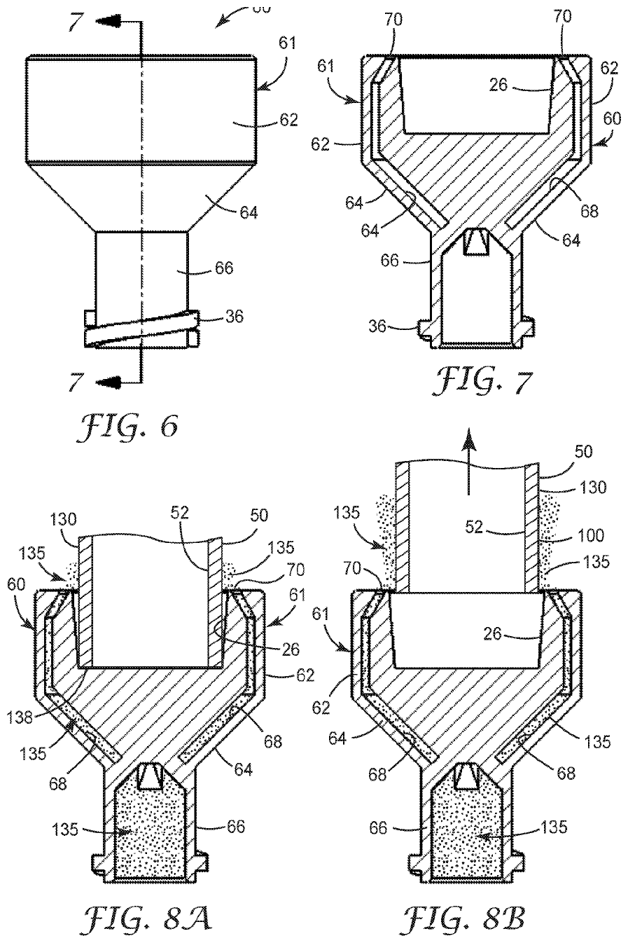

As illustrated in FIGS. 7 and 8A-8B, the nozzle 60 has a sleeve 26 that extends inwardly from the outer surface 16 of the cap at a 90 degree angle relative to the outer surface 16. The sleeve 26 is an annular sleeve which is selected to accommodate or is sized to fit the external surface 130 or diameter of a selected male pipe 50. The spaced opening 70 surrounds the sleeve 26 annularly and is angled to apply a sleeve of adhesive 136 onto the external surface 130 of the male pipe 50. The annularly spaced opening 70 and sleeve 26 together are useful for applying adhesive 135 on the outer or external surface of a tubular body, such as a male pipe 50, and provides the benefits explained above.

As illustrated in FIG. 7, the nozzle 60 include axis B, which is useful for measuring the angle α of the slanted opening 70. The opening 70 may be configured at an angle α of between 5 and 85 degrees relative to the axis A, in one embodiment. In another embodiment, the opening 70 may be configured at an angle α of between 30 and 75 degrees relative to the axis B, preferably, or more preferably at an angle α of between 20 and 45 degrees relative to the axis A. The opening 70 is preferably arranged at an angle α to axis B, like they would be to the length of a male pipe, so that adhesive is dispensed through the spaced orifices in a sleeve-like coating. As discussed above, it is advantageous to have the sleeve-like coating 136 fully tapered because the tapered coating allows the adhesive to get more easily into the overlap section of the joint between the male and female pipes in their respective joining regions 100, 118 more easily. If the adhesive coating isn't tapered, then it is possible that a significant amount of adhesive can potentially be scraped off or pushed out of the overlap of the joining regions, which typically happens in prior art adhesive applicators.

FIGS. 8A and 8B are convenient for illustrating the application of adhesive 135 onto the external surface 130 of a male article, such as a tubular body or male pipe 50. First, the male pipe 50 is selected having an outer diameter that fits well within the diameter of the circular sleeve 26, taking into account the expectation of the width of sleeve 136 of adhesive 135 to be applied to the outer diameter. As illustrated in FIG. 8A, the planar end 138 of the male pipe 50 is inserted into the sleeve 26 of the nozzle 10. The adhesive 135 then flows through the conduit 66 into the funnel portion 64 and then into channel 68 between the barrel portion 62 and the funnel portion 32. From there, the adhesive 135 will flow out of the spaced opening 70 at angle α and be applied to the outer diameter of the male pipe 50, thus creating a sleeve of adhesive 136 on the outside of the male pipe 50. As the adhesive 135 is being applied, the male pipe 50 moves out of the nozzle in the opposite direction in which it was inserted into the nozzle 10. Specifically, the male pipe 50 is withdrawn from the sleeve 26 in a controlled linear movement to apply the sleeve-like coating 136 of adhesive 135 with a uniform thickness, as illustrated in FIG. 8B. Just prior to the planar end 138 exiting or withdrawing from the sleeve 26 of the nozzle 10, the adhesive 135 stops flowing out of the annular spaced opening 70. The movement of the male pipe 50 is determined at a rate in advance so as to apply the sleeve of adhesive 136 in a uniform thickness around the external surface 130 of the male pipe 50. Preferably the sleeve-like coating of adhesive is in a uniform shape axially, and is substantially uniform in thickness. The sleeve-like coating 136 may be tapered near the planar end 138 of the male pipe 50. It is advantageous to have the sleeve-like coating 136 tapered because it helps when the male pipe and female pipe are first joined. One example range of thickness of the adhesive is 0.125-0.1875 inches thick measured axially. The adhesive may be uniform in thickness within this range throughout the length of the sleeve of adhesive (non-tapered), or it may be fully tapered throughout the length of adhesive and within this range, or it may be uniform in thickness in the majority of the sleeve and tapered on a small portion of closest to the planar end of the male pipe with thicknesses within this range. The length of the adhesive on the exterior of the male pipe typically ranges from 0.25 to 0.75 inches in order to obtain an appropriate joining area between the male and female pipe. However, the type of adhesive 135 may be applied at any selected rate to obtain a desired thickness and length. Ideally, the sleeve-like coating of adhesive 136 is substantially not, and preferably not at all on the planer end 138 of the male pipe, after the nozzle 10 applies the adhesive 135.

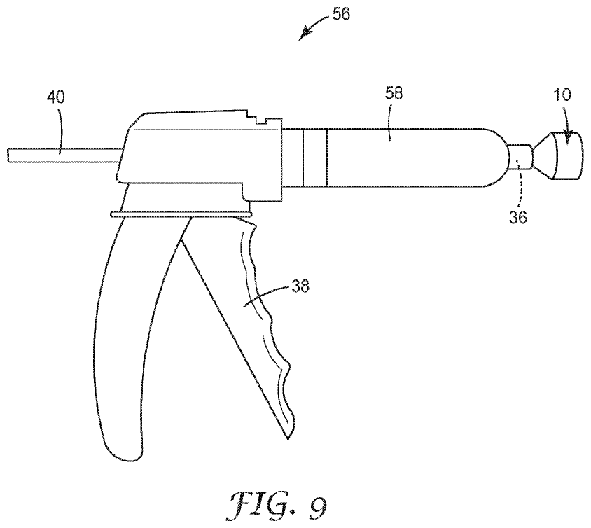

FIG. 9 illustrates a side view of an exemplary adhesive applicator useful with the nozzles of the present invention. The nozzle 10, or other nozzles illustrated herein, may be attached to the adhesive applicator 56 via the threads 36. The adhesive applicator 56 includes an adhesive cartridge 58, a handle 38, and a plunger 40. By depressing the handle 38, the plunger 40 forces the adhesive out of the adhesive cartridge 58 and into the nozzle 10. The nozzle then applies the adhesive to the male pipe (not shown) as described above. One example of a suitable adhesive applicator useful with the nozzles of the present invention is commercially available for 3M Company based in St. Paul, MN as Scotch-weld™ EPX Applicator.

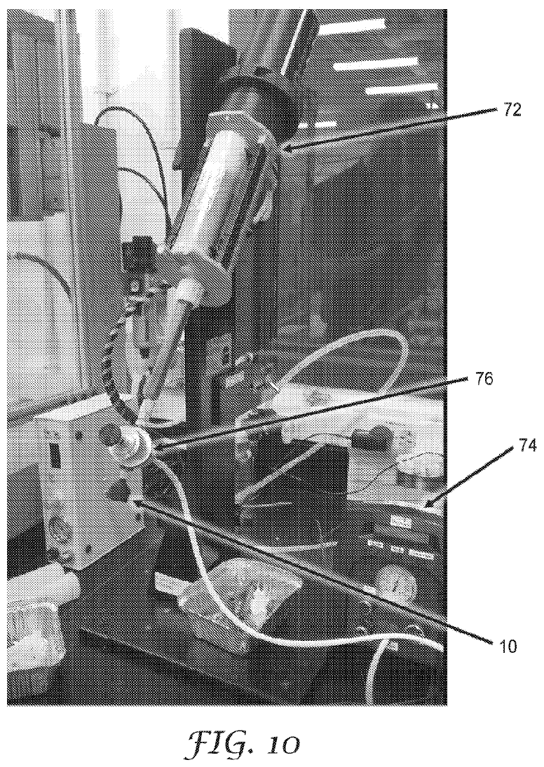

FIG. 10 is a photograph of another suitable stationary adhesive applicator 70. This applicator applies the adhesive through the nozzle 10 of the present invention by use of a controller 74 and pinch valve 76.

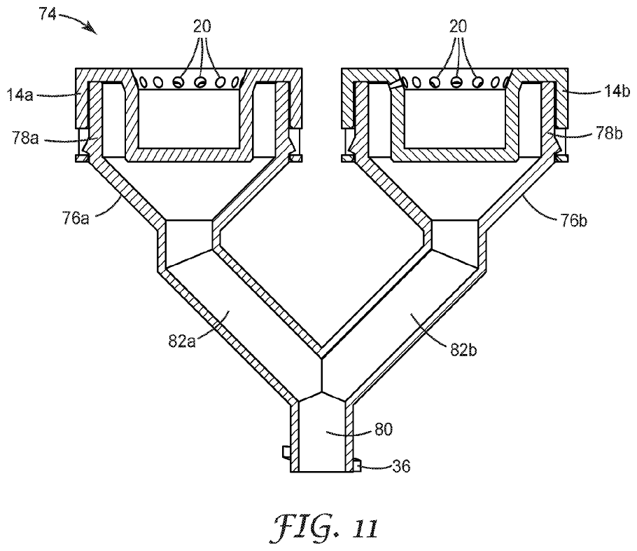

FIGS. 11-14 illustrate alternative embodiments of the nozzles 74, 90, 96 of the present invention. FIG. 11 illustrates a dual nozzle 74 which includes two nozzles just like those illustrated and described in reference to FIGS. 1-5B. Nozzle 74 has a first conduit 80 which is in fluid communication with two conduits 82a, 82b, which each feed a funnel portion 76a, 76b respectively. Each funnel portion 76a, 76b is in fluid communication with a barrel portion 78a, 87b respectively. The adhesive is applied to two male pipes (not show) out of annularly offices 20 in the caps 14a, 15b, as discussed in detail above.

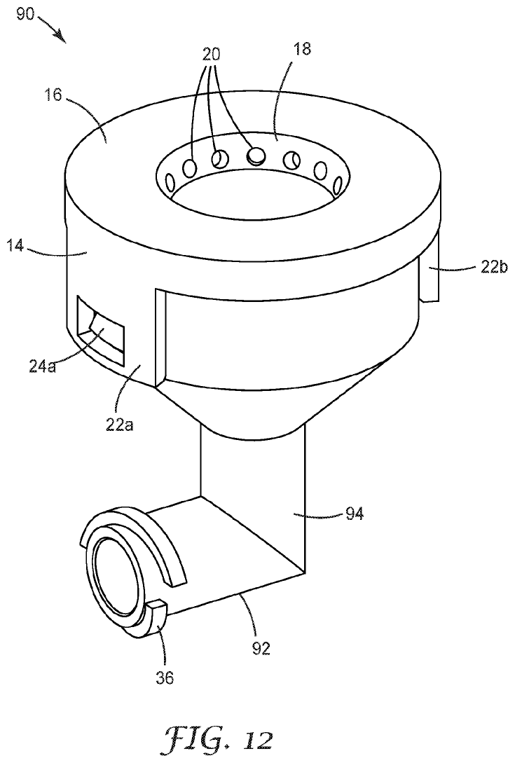

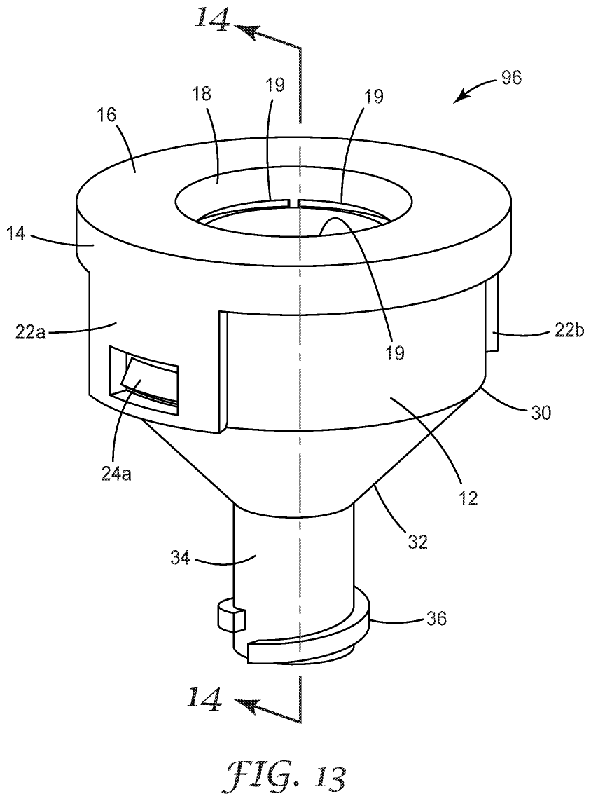

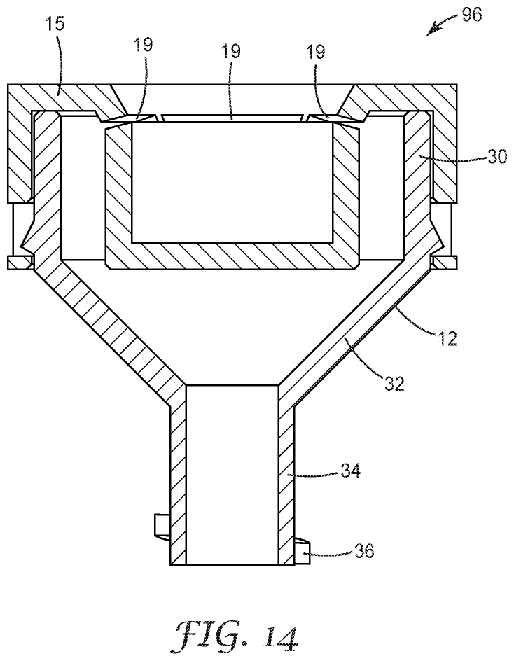

FIG. 12 illustrates nozzle 90, which is just like nozzle 10 illustrated in FIGS. 1-5B, except it includes an elbow made from conduit 92 and conduit 94 FIGS. 13 and 14 illustrate nozzle 96, which is just like nozzle 10 illustrated in FIGS. 1-5B except that it includes annular spaced slits 19 instead of annular spaced orifices 90.

FIGS. 15A-15D help illustrate the process of joining two articles after the use of the nozzle 10 of the present invention to apply a sleeve of adhesive 136. FIG. 15A illustrates a first article 50. The first article 50 is generally configured as a male article 50 and is made of or includes a first metal. The male article 50 includes a joining region 100. At least the joining region 100 of the male article 50 is made of a first metal. FIG. 15A also shows a second article 110. The second article 110 is generally configured as a female article 110 and is made of or includes a second metal. The female article 110 also includes a joining region 118. At least the joining region 118 of the female article 110 is made of a second metal. In one embodiment, the first metal and the second metal are selected from copper (Cu), aluminum (Al), stainless steel, or brass. In a particular embodiment, the first metal and the second metal are copper (Cu) and aluminum (Al) respectively.

A variety of adhesives are suitable for use with the nozzles and applicators of the present invention. The nozzles and applicators of the invention are especially suitable for use in forming a bond between two copper substrates and/or a copper substrate and a substrate of another metal, such as a male and female pipe. The methods include a step of applying a structural adhesive composition to at least a portion of at least one copper substrate. The structural adhesive composition contains an adhesion promoter, wherein adhesion promoter is a compound of formula I,

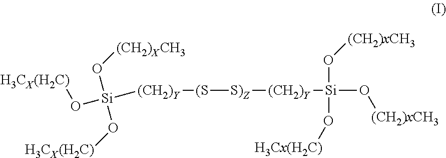

wherein x is an integer from 1 to 4, y is an integer from 2 to 6, and z is an integer from 1 to 6; contacting the portion of the at least one substrate that has the structural adhesive composition applied thereto with a second substrate; and curing the structural adhesive composition to bond the two substrates together, wherein the adhesion promoter is applied within the structural adhesive composition. Once cured, the adhesive composition that forms the adhesive region forms an adhesive bond. Curing the adhesive composition(s) can be accomplished by applying heat to the adhesive compositions, such as via the application of certain wavelengths of energy (i.e., UV triggering of the adhesive), or IR irradiation of the pipe to heat the substrate, or induction curing. The particular method of curing chosen can be based at least in part on the particular adhesive composition(s) being utilized or the substrates being used.

Articles formed using such methods are also disclosed herein. Disclosed articles can include at least two substrates, at least one of which is copper; a structural adhesive composition which contains an adhesion promoter, wherein adhesion promoter is a compound of formula I,

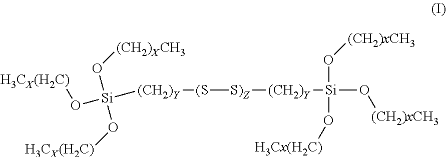

wherein x is an integer from 1 to 4, y is an integer from 2 to 6, and z is an integer from 1 to 6; and the structural adhesive is positioned at least between the two substrates.

In some methods, initial steps can include applying an adhesive composition to at least the joining region of the first article or the male element. In some such embodiments, the adhesive composition can be a 2K epoxy, 2K acrylic, or 2K urethane. In some such embodiments, the adhesive composition can be a 1 part (1K) epoxy adhesives, 1K acrylic adhesives, or 1K urethane.

Generally, adhesive compositions that can be used herein are structural adhesives. Structural adhesives may be divided into two broad categories: one-part adhesives and two-part adhesives. With a one-part adhesive, a single composition comprises all the materials necessary to obtain a final cured adhesive. In the case of thermally cured epoxies, these materials are typically applied to the substrates to be bonded and exposed to elevated temperatures (e.g., temperatures greater than 50° C.) to cure the adhesive.

In contrast, two-part adhesives comprise two components. The first component, typically referred to as the “base resin component,” comprises the curable resin, e.g., a curable epoxy resin. The second component, typically referred to as the “accelerator component,” comprises the curing agent(s) and catalysts. Various other additives may be included in one or both components.

Epoxy resins function as a cross-linkable component in the structural adhesive. The term “epoxy resin” is used herein to mean any of monomeric, dimeric, oligomeric or polymeric epoxy materials containing at least one epoxy functional group per molecule. Such compounds include monomeric epoxy compounds and epoxides of the polymeric type and can be aliphatic, cycloaliphatic, aromatic or heterocyclic. Monomeric and oligomeric epoxy compounds have at least one and preferably one to four polymerizable epoxy groups per molecule. In polymeric type epoxides or epoxy resins, there may be many pendent epoxy groups (for example, a glycidyl methacrylate polymer could have several thousand pendent epoxy groups per average molecular weight).

The molecular weight of the epoxy resins may vary from low molecular weight monomeric or oligomeric epoxy resins with a molecular weight, for example, from about 100 g/mol to epoxy resins with a molecular weight of about 50,000 g/mol or more and may vary greatly in the nature of their backbone and substituent groups. For example, the backbone may be of any type, and substituent groups thereon can be any group not having a nucleophilic group or electrophilic group (such as an active hydrogen atom) which is reactive with an oxirane ring. Illustrative of permissible substituent groups are halogens, ester groups, ethers, sulfonate groups, siloxane groups, nitro groups, amide groups, nitrile groups, phosphate groups, etc. Mixtures of epoxy resins can also be used. In some embodiments, a structural adhesive comprises a mixture of two or more epoxy resins in order to modify and adapt the mechanical properties of the cross-linked structural adhesive with respect to specific requirements.

Types of epoxy resins that can be used include, for example, the reaction product of bisphenol A and epichlorohydrin, the reaction product of phenol and formaldehyde (novolac resin) and epichlorohydrin, peracid epoxies, glycidyl esters, glycidyl ethers, the reaction product of epichlorohydrin and p-amino phenol, the reaction product of epichlorohydrin and glyoxal tetraphenol and the like.

Epoxides that are particularly useful in the present invention are of the glycidyl ether type. Suitable glycidyl ether epoxides may include those in general formula (I):

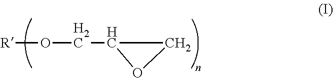

wherein R′is alkyl, alkyl ether, or aryl; n is at least 1 and, in particular, in the range from 1 to 4. Suitable glycidyl ether epoxides of formula (I) include glycidyl ethers of Bisphenol A and F, aliphatic diols or cycloaliphatic diols. In some embodiments the glycidyl ether epoxides of formula (I) have a molecular weight in the range of from about 170 g/mol to about 10,000 g/mol. In other embodiments, the glycidyl ether epoxides of formula (I) have a molecular weight in the range of from about 200 g/mol to about 3,000 g/mol.

Useful glycidyl ether epoxides of formula (I) include linear polymeric epoxides having terminal epoxy groups (for example, a diglycidyl ether of polyoxyalkylene glycol) and aromatic glycidyl ethers (for example, those prepared by reacting a dihydric phenol with an excess of epichlorohydrin). Examples of useful dihydric phenols include resorcinol, catechol, hydroquinone, and the polynuclear phenols including p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, 2,2-dihydroxy-1,1-dinaphrhylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihy droxy dipheny Icy clohexane. Suitable commercially available aromatic and aliphatic epoxides include diglycidylether of bisphenol A (for example, available under the tradename EPON 828, EPON 872, EPON 1001, EPON 1310 and EPONEX 1510 from Hexion Specialty Chemicals GmbH in Rosbach, Germany); DER-331, DER-332, and DER-334 (available from Dow Chemical Co. in Midland, MI); diglycidyl ether of bisphenol F (for example, EPICLON 830 available from Dainippon Ink and Chemicals, Inc.); PEGioooDGE (available from Polysciences, Inc. in Warrington, PA); silicone resins containing diglycidyl epoxy functionality; flame retardant epoxy resins (for example, DER 580, a brominated bisphenol type epoxy resin available from Dow Chemical Co. in Midland, MI); 1,4-dimethanol cyclohexyl diglycidyl ether; and 1,4-butanediol diglycidyl ether. Other epoxy resins based on bisphenols are commercially available under the tradenames D.E.N., EPALLOY and EPILOX. Additional useful resins can include, for example Erisys GA240, Araldite MY0500, and Araldite MY720 (all commercially available from Huntsman International, LLC Texas). In some embodiments, the structural adhesives of the present invention may comprise from about 20% to about 90% by weight epoxy resin. In other embodiments, the structural adhesives may comprise from about 40% to about 70% by weight epoxy resin. In yet other embodiments, the structural adhesives may comprise from about 40% to about 60% by weight epoxy resin.

Methods and articles included herein, wherein the adhesion promoter is a compound of formula I

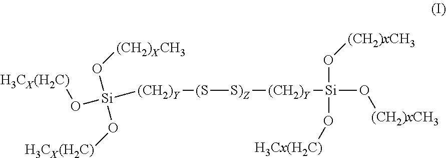

wherein x is an integer from 1 to 4, y is an integer from 2 to 6, and z is an integer from 1 to 6. Any compound of formula I can be used as an adhesion promoter within the structural adhesive composition. In some embodiments, a composition that includes compounds having different number of sulfurs can be utilized as adhesion promoters. In some embodiments, Bis[3-(triethoxysilyl) propyl] disulfide (commercially available under the trade designation “SIB 1824.6”, from Gelest, Inc, Morrisville, PA), Bis[3-(triethoxysilyl) propyl] tetrasulfide (commercially available under the trade designation “SIB 1825.0”, from Gelest, Inc, Morrisville, PA), or combinations thereof can be utilized.

In embodiments where the adhesion promoter is applied within the structural adhesive composition, the compound of formula I can be present in the adhesive composition in an amount from 0.1 wt % to 5 wt %. Although various structural adhesive compositions can be utilized, in some embodiments, useful structural adhesive compositions can include epoxy resins. In some embodiments, the adhesion promoter can be mixed with all components of the structural adhesive except for the catalyst and the accelerant, which can then be added after the composition has cooled.

Male and female pipes that are joined via disclosed methods may have advantageous properties in comparison to pipes joined via other methods. In some embodiments, joined pipes can have advantageous corrosion resistant properties, mechanical strength, leak resistance, fatigue resistance, or combinations thereof.

The pipes that are joined herein may have many pipe configurations, or irregular configurations (e.g., oval, square, etc.).

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

### Exemplary Aspects

Aspect 1 is nozzle for dispensing adhesive, comprising: a main body cavity and a cap releasably attached to the main body cavity; wherein the cap includes spaced orifices for dispensing adhesive on an outer surface of a male pipe and a sleeve extending inwardly from the cap into the main body cavity, wherein the main body cavity includes a barrel portion, a funnel portion and a conduit, and wherein the sleeve is sized to accommodate the outer surface of a selected male pipe.

Aspect 2 is the nozzle of Aspect 1, wherein the orifices are annularly spaced orifices.

Aspect 3 is the nozzle of Aspect 2, wherein the main body cavity has an axis, and the spaced orifices are at an angle of between 5 and 85 degrees relative to the axis.

Aspect 4 is the nozzle of Aspect 3, wherein the spaced orifices are at an angle between 30 and 75 degrees relative to the axis of the main body cavity.

Aspect 5 is the nozzle of Aspect 4, wherein the spaced orifices are at an angle between 20 and 45 degrees relative to the axis of the main body cavity.

Aspect 6 is the nozzle of Aspect 1, further including an adhesive, wherein the adhesive is dispensed through the spaced orifices in a sleeve-like coating.

Aspect 7 is the nozzle of Aspect 6, wherein the conduit is in fluid communication with the funnel portion, the funnel portion is in fluid communication with the barrel portion, and wherein the adhesive flows from the conduit through the funnel portion through the barrel portion and is dispensed through the spaced orifices.

Aspect 8 is the nozzle of Aspect 6, wherein the sleeve-like coating of adhesive is a uniform shape axially.

Aspect 9 is the nozzle of Aspect 6, wherein the sleeve-like coating of adhesive is substantially uniform in thickness.

Aspect 10 is the nozzle of Aspect 6, wherein the sleeve-like coating of adhesive has a tapered thickness having an axial diameter between 0.125 and 0.1875 inches and has a length of 0.25 to 0.75 inches.

Aspect 11 is a combination of the nozzle of Aspect 6 with a male pipe having an outer surface and a first planer end, wherein the sleeve-like coating of adhesive is on the outer surface of the male pipe.

Aspect 12 is the combination of Aspect 11, wherein the sleeve-like coating of adhesive is substantially not on the first planer end of the male pipe.

Aspect 13 is the combination of Aspect 12, wherein the sleeve-like coating of adhesive does not include substantial stringing between the male pipe and the nozzle.

Aspect 14 is the combination of Aspect 11, wherein the male pipe is first inserted into the sleeve of the nozzle, and thereafter withdrawn from the sleeve in a controlled linear movement to apply the sleeve-like coating of adhesive with a tapered uniform thickness.

Aspect 15 is the combination of Aspect 11, wherein the adhesive stops flowing through the spaced orifices prior to withdrawal of the male pipe from the nozzle.

Aspect 16 is the nozzle of Aspect 1, further including an adhesive, wherein the adhesive is dispensed through the spaced orifices and wherein the adhesive comprises a 1-part (1K) epoxy adhesive.

Aspect 17 is the nozzle of Aspect 1, further including an adhesive, wherein the adhesive is dispensed through the spaced orifices and wherein the adhesive comprises a 2-part (2K) epoxy adhesive.

Aspect 18 is the nozzle of Aspect 1, further including an adhesive, wherein the adhesive is dispensed through the spaced orifices and wherein the adhesive comprises a structural adhesive composition comprising: a resin; and from 0.1 to 5 wt % of one or more compounds of formula I

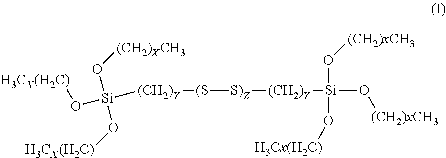

wherein x is an integer from 1 to 4, y is an integer from 2 to 6, and z is an integer from 1 to 6.

Aspect 19 is the nozzle of Aspect 18, wherein the resin comprises an epoxy resin.

Aspect 20 is the nozzle of Aspect 18 or 19, wherein the compound of formula I is Bis[3-(triethoxysilyl) propyl] disulfide.

Aspect 21 is the nozzle of Aspect 18 or 19, wherein the compound of formula I is Bis[3-(triethoxysilyl) propyl] tetrasulfide.

Aspect 22 is the nozzle of Aspect 18, wherein the structure adhesive composition comprises acrylic adhesive, 1K urethane adhesive, 2K urethane adhesive, or combinations thereof.

Aspect 23 is a nozzle for dispensing adhesive, comprising: a main body cavity and a sleeve is sized to accommodate the outer surface of a selected male pipe; wherein the main body cavity includes a barrel portion, a funnel portion and a conduit; wherein the main body cavity_and sleeve form a spaced opening for dispensing adhesive on the outer surface of a male pipe; a channel for an adhesive to flow through from the conduit to the spaced opening, wherein the channel is formed between sleeve and the funnel and barrel portions.

Aspect 24 is the nozzle of Aspect 23, wherein the spaced opening is an annularly spaced ring.

Aspect 25 is the nozzle of Aspect 24, wherein the annular spaced ring is sized for dispensing adhesive on the outer surface of a male pipe of desired size.

Aspect 26 is the nozzle of Aspect 24, wherein the annular spaced opening includes a plurality of annular spaced openings.

Aspect 27 is the nozzle of Aspect 26, wherein the main body cavity has an axis, and the annular spaced openings are at an angle of between 5 and 85 degrees relative to the axis.

Aspect 28 is the nozzle of Aspect 27, wherein the spaced orifices are at an angle of between 30 and 75 degrees relative to the axis of the main body cavity.

Aspect 29 is the nozzle of Aspect 28, wherein the spaced orifices are at an angle of between 20 and 45 degrees relative to the axis of the main body cavity.

Aspect 30 is the nozzle of Aspect 23, further including an adhesive, wherein the adhesive is dispensed through the spaced orifices in a sleeve-like coating.

Aspect 31 is the nozzle of Aspect 30, wherein the conduit is in fluid communication with the funnel portion, the funnel portion is in fluid communication with the barrel portion, wherein the adhesive flows from the conduit through the funnel portion through the barrel portion and is dispensed through the spaced opening.

Aspect 32 is the nozzle of Aspect 30, wherein the sleeve-like coating of adhesive is a uniform shape axially.

Aspect 33 is the nozzle of Aspect 30, wherein the sleeve-like coating of adhesive is substantially uniform in thickness.

Aspect 34 is the nozzle of Aspect 30, wherein the sleeve-like coating of adhesive has a tapered thickness having an axial diameter between 0.125 and 0.1875 inches and has a length of 0.25 to 0.75 inches.

Aspect 35 is a combination of the nozzle of Aspect 30 with a male pipe having an outer surface and a first planer end, wherein the sleeve-coating of adhesive is on the outer surface of the male pipe.

Aspect 36 is the combination of Aspect 35, wherein the sleeve-like coating of adhesive is substantially not on the first planer end of the male pipe.

Aspect 37 is the combination of Aspect 36, wherein the sleeve-like coating of adhesive does not include substantial stringing between the male pipe and the nozzle.

Aspect 38 is the combination of Aspect 35, wherein the male pipe is first inserted into the sleeve of the nozzle, and thereafter withdrawn from the sleeve in a controlled linear movement to apply the sleeve-like coating of adhesive with a tapered uniform thickness.

Aspect 39 is the combination of Aspect 35, wherein the adhesive stops flowing through the spaced orifices prior to withdrawal of the pipe from the nozzle.

Aspect 40 is the nozzle of Aspect 23, further including an adhesive, wherein the adhesive is dispensed through the spaced orifices and wherein the adhesive comprises a 1-part (1K) epoxy adhesive.

Aspect 41 is the nozzle of Aspect 23, further including an adhesive, wherein the adhesive is dispensed through the spaced orifices and wherein the adhesive comprises a 2-part (2K) epoxy adhesive.

Aspect 42 is the nozzle of Aspect 23, further including an adhesive, wherein the adhesive is dispensed through the spaced orifices and wherein the adhesive comprises a structural adhesive composition comprising: a resin; and from 0.1 to 5 wt % of one or more compounds of formula I

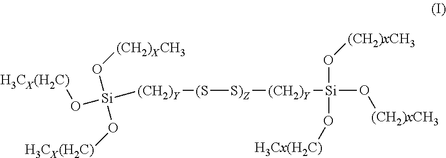

wherein x is an integer from 1 to 4, y is an integer from 2 to 6, and z is an integer from 1 to 6.

Aspect 43 is the nozzle of Aspect 42, wherein the resin comprises an epoxy resin.

Aspect 44 is the nozzle of Aspect 42 or 43, wherein the compound of formula I is Bis[3-(triethoxysilyl) propyl] disulfide.

Aspect 45 is the nozzle of Aspect 42 or 43, wherein the compound of formula I is Bis[3-(triethoxysilyl) propyl] tetrasulfide.

Aspect 46 is the nozzle of Aspect 42, wherein the structure adhesive composition comprises acrylic adhesive, 1K urethane adhesive, 2K urethane adhesive, or combinations thereof.

Aspect 47 is a dual nozzle for dispensing adhesive, comprising: a first main body cavity and a first cap releasably attached to the main body cavity; wherein the first cap includes spaced orifices for dispensing adhesive on an outer surface of a first male pipe and a first sleeve extending from the first cap; wherein the first main body cavity includes a barrel portion, a funnel portion and a conduit, and wherein the first sleeve is sized to accommodate the outer surface of a first male pipe; and a second main body cavity and a second cap releasably attached to the first main body cavity; wherein the second cap includes spaced orifices for dispensing adhesive on an outer surface of a second male pipe and a first sleeve extending from the second cap; wherein the second main body cavity includes a barrel portion, a funnel portion and a conduit, and wherein the second sleeve is sized to accommodate the outer surface of a second male pipe.

Aspect 48 is the dual nozzle of Aspect 47 wherein the first sleeve extends inwardly toward the barrel portion of the first main body cavity; and wherein the second sleeve extends inwardly toward the barrel portion of the second main body cavity.

Aspect 49 is the dual nozzle of Aspect 47, wherein the orifices are annularly spaced orifices.

Aspect 50 is the dual nozzle of Aspect 49, wherein the main body cavity has an axis, and the spaced orifices are at an angle of between 5 and 85 degrees relative to the axis.

Aspect 51 is the dual nozzle of Aspect 50, wherein the spaced orifices are at an angle of between 30 and 75 degrees relative to the axis of the main body cavity.

Aspect 52 is the dual nozzle of Aspect 51, wherein the spaced orifices are at an angle between 20 and 45 degrees relative to the axis of the main body cavity.

Aspect 53 is the dual nozzle of Aspect 47, further including an adhesive, wherein the adhesive is dispensed through the spaced orifices in the first cap in a first sleeve-like coating, and wherein the adhesive is dispensed through the spaced orifices in the second cap in a second sleeve-like coating.

Aspect 54 is the dual nozzle of Aspect 53, wherein the conduit is in fluid communication with both of the funnel portions of the first main body cavity and the second main body cavity, wherein the funnel portion of the first main body cavity is in fluid communication with the barrel portion of the first main body cavity, wherein the funnel portion of the second main body cavity is in fluid communication with the barrel portion of the second main body cavity, wherein the adhesive flows from the conduit through the funnel portion through the barrel portion of the first main body cavity and is dispensed through the spaced orifices of the first cap, and wherein the adhesive flows from the conduit through the funnel portion through the barrel portion of the second main body cavity and is dispensed through the spaced orifices of the second cap.

Aspect 55 is the dual nozzle of Aspect 53, wherein the first and second sleeve-like coatings of adhesive are a uniform shape axially.

Aspect 56 is the dual nozzle of Aspect 53, wherein the first and second sleeve-like coatings of adhesive are substantially uniform in thickness.

Aspect 57 is the dual nozzle of Aspect 53, wherein the sleeve-like coating of adhesive has a tapered thickness having an axial diameter between 0.125 and 0.1875 inches and has a length of 0.25 to 0.75 inches.

Aspect 58 is a combination of the dual nozzle of Aspect 53 with a first male pipe having an outer surface and a first planer end and second male pipe having an outer surface and a first planer end, wherein the first sleeve-like coating of adhesive is on the outer surface of the first male pipe, and wherein the second sleeve-like coating of adhesive is on the outer surface of the second male pipe.

Aspect 60 is the combination of Aspect 58, wherein the first sleeve-like coating of adhesive is substantially not on the first planer end of the first male pipe, and wherein the second sleeve-like coating of adhesive is substantially not on the first planer end of the second male pipe.

Aspect 61 is the combination of Aspect 60, wherein the sleeve-like coating of adhesive does not include substantial stringing between the first and second male pipes and the dual nozzle.

Aspect 62 is the combination of Aspect 58, wherein the first male pipe is first inserted into the first sleeve of the dual nozzle, and thereafter withdrawn from the first sleeve in a controlled linear movement to apply the sleeve-like coating of adhesive with a tapered uniform thickness, and wherein the second male pipe is first inserted into the second sleeve of the dual nozzle, and thereafter withdrawn from the second sleeve in a controlled linear movement to apply the sleeve-like coating of adhesive with a tapered uniform thickness.

Aspect 63 is the combination of Aspect 58, wherein the adhesive stops flowing through the spaced orifices prior to withdrawal of the pipe from the dual nozzle.

Aspect 64 is the dual nozzle of Aspect 47, further including an adhesive, wherein the adhesive is dispensed through the spaced orifices of the first cap and second cap, and wherein the adhesive comprises a 1-part (1K) epoxy adhesive.

Aspect 65 is the dual nozzle of Aspect 47, further including an adhesive, wherein the adhesive is dispensed through the spaced orifices of the first cap and second cap, and wherein the adhesive comprises a 2-part (2K) epoxy adhesive.

Aspect 66 is the dual nozzle of Aspect 47, further including an adhesive, wherein the adhesive is dispensed through the spaced orifices of the first cap and second cap, and wherein the adhesive comprises a structural adhesive composition comprising: a resin; and from 0.1 to 5 wt % of one or more compounds of formula I

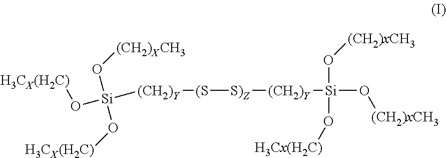

wherein x is an integer from 1 to 4, y is an integer from 2 to 6, and z is an integer from 1 to 6.

Aspect 67 is the dual nozzle of Aspect 66, wherein the resin comprises an epoxy resin.

Aspect 68 is the dual nozzle of Aspect 66 or 67, wherein the compound of formula I is Bis[3-(triethoxysilyl) propyl] disulfide.

Aspect 69 is the dual nozzle of Aspect 66 or 67, wherein the compound of formula I is Bis[3-(triethoxysilyl) propyl] tetrasulfide.

Aspect 70 is the dual nozzle of Aspect 66, wherein the structure adhesive composition comprises acrylic adhesive, 1K urethane adhesive, 2K urethane adhesive, or combinations thereof.

Aspect 71 is a dual nozzle for dispensing adhesive, comprising: a first main body cavity and a first cap releasably attached to the first main body cavity; wherein the first cap includes a first sleeve is sized to accommodate the outer surface of a first male pipe; wherein the first main body cavity includes a barrel portion, a funnel portion and a conduit; wherein the first cap and first sleeve form a first spaced opening for dispensing adhesive on the outer surface of the first male pipe; and a first channel for an adhesive to flow through from the conduit to the spaced opening, wherein the channel is formed between the first sleeve and the funnel and barrel portions; and a second main body cavity and a second cap releasably attached to the second main body cavity; wherein the second cap includes a second sleeve is sized to accommodate the outer surface of a second male pipe; wherein the second main body cavity includes a barrel portion, a funnel portion and a conduit; wherein the second cap and second sleeve form a second spaced opening for dispensing adhesive on the outer surface of the second male pipe; and a second channel for an adhesive to flow through from the conduit to the spaced opening, wherein the second channel is formed between the second sleeve and the funnel and barrel portions.

Aspect 72 is the dual nozzle of Aspect 71, wherein the first and second spaced openings are each annularly spaced rings.

Aspect 73 is the dual nozzle of Aspect 72, wherein the annular spaced rings are each sized for dispensing adhesive on the outer surface of a first and second male pipes of desired size.

Aspect 74 is the dual nozzle of Aspect 73, wherein the annular spaced openings each include a plurality of annular spaced openings.

Aspect 75 is the dual nozzle of Aspect 71 wherein the first sleeve extends inwardly toward the barrel portion of the first main body cavity; and wherein the second sleeve extends inwardly toward the barrel portion of the second main body cavity.

Aspect 76 is the dual nozzle of Aspect 74, wherein the first main body cavity has a first axis and the second main body cavity has a second axis, and the plurality of annular spaced openings are at an angle of between 5 and 85 degrees relative to the axis.

Aspect 77 is the dual nozzle of Aspect 76, wherein the plurality of annular spaced openings are between 30 and 75 degrees relative to the axis of the main body cavity.

Aspect 78 is the dual nozzle of Aspect 77, wherein the plurality of annular spaced orifices are between 20 and 45 degrees relative to the axis of the main body cavity.

Aspect 79 is the dual nozzle of Aspect 71, further including an adhesive, wherein the adhesive is dispensed through the spaced opening in the first cap in a first sleeve-like coating and wherein the adhesive is dispensed through the spaced opening in the second cap in a second sleeve-like coating.

Aspect 80 is the dual nozzle of Aspect 71, wherein the conduit is in fluid communication with the funnel portions of the first main body cavity and the second main body cavity, wherein the funnel portion of the first main body cavity is in fluid communication with the barrel portion of the first main body cavity, wherein the funnel portion of the second main body cavity is in fluid communication with the barrel portion of the second main body cavity, wherein the adhesive flows from the conduit through the funnel portion through the barrel portion of the first main body cavity and is dispensed through the spaced opening of the first cap, and wherein the adhesive flows from the conduit through the funnel portion through the barrel portion of the second main body cavity and is dispensed through the spaced opening of the second cap.

Aspect 81 is the dual nozzle of Aspect 79, wherein the first and second sleeve-like coatings of adhesive are a uniform shape axially.

Aspect 82 is the dual nozzle of Aspect 79, wherein the first and second sleeve-like coatings of adhesive are substantially uniform in thickness.

Aspect 83 is the dual nozzle of Aspect 79, wherein the sleeve-like coating of adhesive has a tapered thickness having an axial diameter between 0.125 and 0.1875 inches and has a length of 0.25 to 0.75 inches.

Aspect 84 is a combination of the dual nozzle of Aspect 71 with a first male pipe having an outer surface and a first planer end and second male pipe having an outer surface and a first planer end, wherein the first sleeve-like coating of adhesive is on the outer surface of the first male pipe, and wherein the second sleeve-like coating of adhesive is on the outer surface of the second male pipe.

Aspect 85 is the combination of Aspect 58, wherein the first sleeve-like coating of adhesive is substantially not on the first planer end of the first male pipe, and wherein the second sleeve-like coating of adhesive is substantially not on the first planer end of the second male pipe.

Aspect 86 is the combination of Aspect 79, wherein the sleeve-like coating of adhesive does not include substantial stringing between the male pipe and the dual nozzle.

Aspect 87 is the combination of Aspect 71, wherein a first male pipe is first inserted into the sleeve of the dual nozzle, and thereafter withdrawn from the sleeve in a controlled linear movement to apply the sleeve-like coating of adhesive with a tapered uniform thickness.

Aspect 88 is the combination of Aspect 79, wherein the adhesive stops flowing through the spaced orifices prior to withdrawal of the pipe from the dual nozzle.

Aspect 89 is the dual nozzle of Aspect 71, further including an adhesive, wherein the adhesive is dispensed through the spaced orifices of the first cap and second cap, and wherein the adhesive comprises a 1-part (1K) epoxy adhesive.

Aspect 90 is the dual nozzle of Aspect 71, further including an adhesive, wherein the adhesive is dispensed through the spaced orifices of the first cap and second cap, and wherein the adhesive comprises a 2-part (2K) epoxy adhesive.

Aspect 91 is the dual nozzle of Aspect 71, further including an adhesive, wherein the adhesive is dispensed through the spaced orifices of the first cap and second cap, and wherein the adhesive comprises a structural adhesive composition comprising: a resin; and from 0.1 to 5 wt % of one or more compounds of formula I

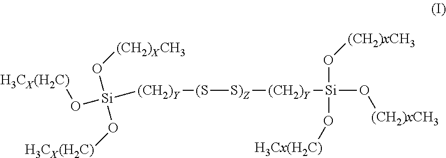

wherein x is an integer from 1 to 4, y is an integer from 2 to 6, and z is an integer from 1 to 6.

Aspect 92 is the dual nozzle of Aspect 91, wherein the resin comprises an epoxy resin.

Aspect 93 is the dual nozzle of Aspect 91 or 92, wherein the compound of formula I is Bis[3-(triethoxysilyl) propyl] disulfide.

Aspect 94 is the dual nozzle of Aspect 91 or 92, wherein the compound of formula I is Bis[3-(triethoxysilyl) propyl] tetrasulfide.

Aspect 95 is the dual nozzle of Aspect 91, wherein the structure adhesive composition comprises acrylic adhesive, 1K urethane adhesive, 2K urethane adhesive, or combinations thereof.

Aspect 96 is a method of applying adhesive, comprising: providing a nozzle of Aspects 1, 23, 47, or 71; providing an adhesive to flow through the nozzle; providing a male pipe and a female pipe, wherein the male pipe comprises a first metal, and wherein the female pipe comprising a second metal; applying an adhesive composition to a male pipe; inserting at least a portion of the adhesive composition and the male pipe into the female pipe thereby forming an interface between the male pipe and the female pipe; and curing the adhesive composition to form an adhesive bond between the male pipe and the female pipe, wherein the cured adhesive composition limits corrosion of at least a portion of the male pipe, the female pipe, or both.

Aspect 97 is the method according to Aspect 96, wherein the adhesive composition comprises a 1 part (1K) epoxy adhesive.

Aspect 98 is the method according to Aspect 96, wherein the adhesive composition comprises a 2 part (2K) epoxy adhesive.

Aspect 99 is the method according to Aspect 96, wherein the adhesive composition comprises acrylic adhesive, 1K urethane adhesive, 2K urethane adhesive, or combinations thereof.

Aspect 100 is the method according to any of Aspects 19 to 99, wherein the first metal and the second metal are selected from copper (Cu), aluminum (Al), brass, or stainless steel.

Aspect 101 is the method according to any of Aspects 96 to 100, wherein the cured adhesive composition covers a portion of the external surface of the male element.

Aspect 102 is the method according to any of Aspects 96 to 101, wherein the cured adhesive composition covers a portion of the external surface of the female element.

Aspect 103 is the method according to any of the preceding Aspects, wherein the cured adhesive composition covers both a portion of the external surface of the male element and a portion of the external surface of the female element.

Aspect 104 is the method according to any of Aspects 96 to 103, wherein the step of curing occurs at temperatures above room temperature.

Aspect 105 is the method according to any of Aspects 96 to 103, wherein the step of curing occurs at room temperature.

1-22. (canceled)

23. A nozzle for dispensing adhesive, comprising:
a main body cavity and a sleeve is sized to accommodate the outer surface of a selected male pipe;
wherein the main body cavity includes a barrel portion, a funnel portion and a conduit;
wherein the main body cavity and sleeve form a spaced opening for dispensing adhesive on the outer surface of a male pipe, wherein the spaced opening is an annularly spaced ring;
a channel for an adhesive to flow through from the conduit to the spaced opening, wherein the channel is formed between sleeve and the funnel and barrel portions.

24. (canceled)

25. The nozzle of claim 23, wherein the annular spaced ring is sized for dispensing adhesive on the outer surface of a male pipe of desired size.

26. The nozzle of claim 23, wherein the annular spaced opening includes a plurality of annular spaced openings.

27. The nozzle of claim 26, wherein the main body cavity has an axis, and the annular spaced openings are at an angle of between 5 and 85 degrees relative to the axis.

28. The nozzle of claim 27, wherein the spaced orifices are at an angle of between 30 and 75 degrees relative to the axis of the main body cavity.

29. The nozzle of claim 28, wherein the spaced orifices are at an angle of between 20 and 45 degrees relative to the axis of the main body cavity.

30. The nozzle of claim 23, further including an adhesive, wherein the adhesive is dispensed through the spaced orifices in a sleeve-like coating.

31. The nozzle of claim 30, wherein the conduit is in fluid communication with the funnel portion, the funnel portion is in fluid communication with the barrel portion, wherein the adhesive flows from the conduit through the funnel portion through the barrel portion and is dispensed through the spaced opening.

32-39. (canceled)

40. The nozzle of claim 23, further including an adhesive, wherein the adhesive is dispensed through the spaced orifices and wherein the adhesive comprises a 1-part (1K) epoxy adhesive.

41. The nozzle of claim 23, further including an adhesive, wherein the adhesive is dispensed through the spaced orifices and wherein the adhesive comprises a 2-part (2K) epoxy adhesive.

42. The nozzle of claim 23, further including an adhesive, wherein the adhesive is dispensed through the spaced orifices and wherein the adhesive comprises a structural adhesive composition comprising:
a resin; and
from 0.1 to 5 wt % of one or more compounds of formula I 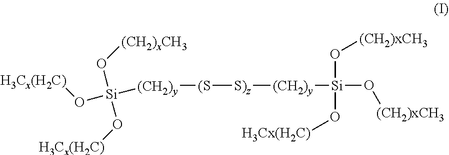
wherein x is an integer from 1 to 4,
y is an integer from 2 to 6, and
z is an integer from 1 to 6.

43. The nozzle of claim 42, wherein the resin comprises an epoxy resin.

44. The nozzle of claim 42, wherein the compound of formula I is Bis[3-(triethoxysilyl) propyl] disulfide.

45. The nozzle of claim 42, wherein the compound of formula I is Bis[3-(triethoxysilyl) propyl] tetrasulfide.

46. The nozzle of claim 42, wherein the structure adhesive composition comprises acrylic adhesive, 1K urethane adhesive, 2K urethane adhesive, or combinations thereof.

47. A dual nozzle for dispensing adhesive, comprising:
a first main body cavity and a first cap releasably attached to the main body cavity;
wherein the first cap includes spaced orifices for dispensing adhesive on an outer surface of a first male pipe and a first sleeve extending from the first cap;
wherein the first main body cavity includes a barrel portion, a funnel portion and a conduit, and wherein the first sleeve is sized to accommodate the outer surface of a first male pipe; and
a second main body cavity and a second cap releasably attached to the first main body cavity;
wherein the second cap includes spaced orifices for dispensing adhesive on an outer surface of a second male pipe and a first sleeve extending from the second cap;
wherein the second main body cavity includes a barrel portion, a funnel portion and a conduit, and wherein the second sleeve is sized to accommodate the outer surface of a second male pipe.

48. The dual nozzle of claim 47 wherein the first sleeve extends inwardly toward the barrel portion of the first main body cavity; and wherein the second sleeve extends inwardly toward the barrel portion of the second main body cavity.

49. The dual nozzle of claim 47, wherein the orifices are annularly spaced orifices.

50. The dual nozzle of claim 49, wherein the main body cavity has an axis, and the spaced orifices are at an angle of between 5 and 85 degrees relative to the axis.

51. The dual nozzle of claim 50, wherein the spaced orifices are at an angle of between 30 and 75 degrees relative to the axis of the main body cavity.

52. The dual nozzle of claim 51, wherein the spaced orifices are at an angle between 20 and 45 degrees relative to the axis of the main body cavity.

53. (canceled)

54. The dual nozzle of claim 53, wherein the conduit is in fluid communication with both of the funnel portions of the first main body cavity and the second main body cavity, wherein the funnel portion of the first main body cavity is in fluid communication with the barrel portion of the first main body cavity, wherein the funnel portion of the second main body cavity is in fluid communication with the barrel portion of the second main body cavity, wherein the adhesive flows from the conduit through the funnel portion through the barrel portion of the first main body cavity and is dispensed through the spaced orifices of the first cap, and wherein the adhesive flows from the conduit through the funnel portion through the barrel portion of the second main body cavity and is dispensed through the spaced orifices of the second cap.

55-63. (canceled)

64. The dual nozzle of claim 47, further including an adhesive, wherein the adhesive is dispensed through the spaced orifices of the first cap and second cap, and wherein the adhesive comprises a 1-part (1K) epoxy adhesive.

65. The dual nozzle of claim 47, further including an adhesive, wherein the adhesive is dispensed through the spaced orifices of the first cap and second cap, and wherein the adhesive comprises a 2-part (2K) epoxy adhesive.

66. The dual nozzle of claim 47, further including an adhesive, wherein the adhesive is dispensed through the spaced orifices of the first cap and second cap, and wherein the adhesive comprises a structural adhesive composition comprising:
a resin; and
from 0.1 to 5 wt % of one or more compounds of formula I 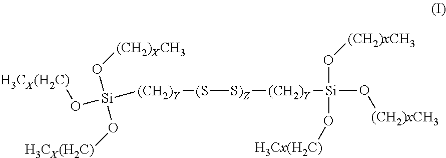
wherein x is an integer from 1 to 4,
y is an integer from 2 to 6, and
z is an integer from 1 to 6.

67. The dual nozzle of claim 66, wherein the resin comprises an epoxy resin.

68. The dual nozzle of claim 66, wherein the compound of formula I is Bis[3-(triethoxysilyl) propyl] disulfide.

69. The dual nozzle of claim 66, wherein the compound of formula I is Bis[3-(triethoxysilyl) propyl] tetrasulfide.

70. The dual nozzle of claim 66, wherein the structure adhesive composition comprises acrylic adhesive, 1K urethane adhesive, 2K urethane adhesive, or combinations thereof.

71. A dual nozzle for dispensing adhesive, comprising:
a first main body cavity and a first cap releasably attached to the first main body cavity;
wherein the first cap includes a first sleeve is sized to accommodate the outer surface of a first male pipe;
wherein the first main body cavity includes a barrel portion, a funnel portion and a conduit;
wherein the first cap and first sleeve form a first spaced opening for dispensing adhesive on the outer surface of the first male pipe; and
a first channel for an adhesive to flow through from the conduit to the spaced opening,
wherein the channel is formed between the first sleeve and the funnel and barrel portions; and
a second main body cavity and a second cap releasably attached to the second main body cavity;
wherein the second cap includes a second sleeve is sized to accommodate the outer surface of a second male pipe;
wherein the second main body cavity includes a barrel portion, a funnel portion and a conduit;
wherein the second cap and second sleeve form a second spaced opening for dispensing adhesive on the outer surface of the second male pipe; and
a second channel for an adhesive to flow through from the conduit to the spaced opening, wherein the second channel is formed between the second sleeve and the funnel and barrel portions.

72. The dual nozzle of claim 71, wherein the first and second spaced openings are each annularly spaced rings.

73. The dual nozzle of claim 72, wherein the annular spaced rings are each sized for dispensing adhesive on the outer surface of a first and second male pipes of desired size.

74. The dual nozzle of claim 73, wherein the annular spaced openings each include a plurality of annular spaced openings.

75. The dual nozzle of claim 71 wherein the first sleeve extends inwardly toward the barrel portion of the first main body cavity; and wherein the second sleeve extends inwardly toward the barrel portion of the second main body cavity.

76. The dual nozzle of claim 74, wherein the first main body cavity has a first axis and the second main body cavity has a second axis, and the plurality of annular spaced openings are at an angle of between 5 and 85 degrees relative to the axis.

77. The dual nozzle of claim 76, wherein the plurality of annular spaced openings are between 30 and 75 degrees relative to the axis of the main body cavity.

78. The dual nozzle of claim 77, wherein the plurality of annular spaced orifices are between 20 and 45 degrees relative to the axis of the main body cavity.

79. The dual nozzle of claim 71, further including an adhesive, wherein the adhesive is dispensed through the spaced opening in the first cap in a first sleeve-like coating and wherein the adhesive is dispensed through the spaced opening in the second cap in a second sleeve-like coating.

80. The dual nozzle of claim 71, wherein the conduit is in fluid communication with the funnel portions of the first main body cavity and the second main body cavity, wherein the funnel portion of the first main body cavity is in fluid communication with the barrel portion of the first main body cavity, wherein the funnel portion of the second main body cavity is in fluid communication with the barrel portion of the second main body cavity, wherein the adhesive flows from the conduit through the funnel portion through the barrel portion of the first main body cavity and is dispensed through the spaced opening of the first cap, and wherein the adhesive flows from the conduit through the funnel portion through the barrel portion of the second main body cavity and is dispensed through the spaced opening of the second cap.

81-105. (canceled)
